(19) United States
(12) Patent Application Publication
(10) Pub. No.: US 2016/0200851 A1
(43) Pub. Date: Jul. 14, 2016

(54) Optical Film Having Reverse Wavelength Dispersion and Display Device Including the Same (As Amended)

(71) Applicant: LG CHEM, LTD., Yeongdeungpo-gu, Seoul (KR)

(72) Inventors: Sung Kyoung LEE, Daejeon (KR); Dai Seung CHOI, Daejeon (KR); Eun Seok PARK, Daejeon (KR); Sung-Ho CHUN, Daejeon (KR)

(21) Appl. No.: 14/911,706

(22) PCT Filed: Aug. 18, 2014
(86) PCT No.: PCT/KR2014/007633

§ 371 Date: Feb. 11, 2016

(30) Foreign Application Priority Data
Aug. 19, 2013 (KR) 10-2013-0098090
Aug. 18, 2014 (KR) 10-2014-0106947

(51) Int. Cl. C08F 226/12; G02B 5/30; B29C 55/00; C08J 5/18

(52) U.S. Cl. CPC C08F 226/12; C08J 5/18; G02B 5/3083; B29C 55/00; C08J 2339/04; B29K 2033/08

(57) ABSTRACT

An optical film having reverse wavelength dispersion and a display device including the same are provided. The optical film according to the present invention has a thin thickness and excellent reverse wavelength dispersion, and thus it can be suitably applied to a λ/2 wave plate, a λ/4 wave plate, a protection film, and an anti-reflection film of a display device using liquid crystals or OLEDs.

### TECHNICAL FIELD

The present disclosure relates to an optical film having reverse wavelength dispersion and a display device including the same.

### BACKGROUND OF ART

A phase retarder is a type of optical element that changes the polarization state of light passing through the same, and is also called a wave plate. When an electromagnetic wave passes through the phase retarder, the polarization direction thereof (direction of the electric field vector) becomes a sum of two components (an ordinary ray and an extraordinary ray) parallel or perpendicular to the optic axis, and changes as the vector sum of the components varies depending upon the birefringence and thickness of the phase retarder. In this regard, a wave plate that changes the polarization direction by 90 degrees is called a quarter-wave plate (λ/4), and a wave plate that changes the polarization direction by 180 degrees is called a half-wave (λ/2) plate.

In this regard, the phase difference value of the phase retarder depends on the wavelength, and the wavelength dispersion of the phase difference value is classified into normal wavelength dispersion, flat wavelength dispersion, and reverse wavelength dispersion.

The phase retarder showing the reverse wavelength dispersion is most useful among them because it has specific phase differences (λ/4, λ/2, and so on) in a wide wavelength band, but the phase retarders formed from common resin films generally show normal wavelength dispersion.

In order to resolve such problem, many studies have been carried out. For example, Japanese Patent Publication Nos. 1998-068816, 1998-090521, 1999-052131, and 2000-002841 disclose laminate-type phase retarders formed by laminating a plurality of optically anisotropic layers. However, the laminate-type phase retarder having a lamination structure of a plurality of optically anisotropic layers has a disadvantage of low production yield and high production cost because the production process of the phase retarder requires a complicated process of not only arranging a plurality of films but also controlling the optical orientation of the films.

Meanwhile, Japanese Patent Publication No. 2002-221622 discloses a method of preparing a broadband λ/4 wave plate including only one phase retarder by inducing reverse wavelength dispersion through film drawing. However, such wave plate is unsuitable for liquid crystal display devices requiring lamellation because the thickness of the plate is 100 μm or more.

Further, Japanese Patent Publication No. 2002-267838 discloses a method of using a liquid crystal composition including a rod-shaped liquid crystal compound and a non-liquid crystal material that is oriented perpendicularly to the major axis of the rod-shaped liquid crystal compound, for the purpose of preparing a thin layer broadband wave plate. However, in the case of the composition, there is a disadvantage that the reverse wavelength dispersion cannot be induced when the mixing ratio of the non-liquid crystal material is low, and the liquid crystal characteristics of the composition itself may be lost when the mixing ratio is high.

Therefore, there is a demand for the development of a thin broadband phase retarder which can exhibit stable reverse wavelength dispersion, and particularly, there is an urgent need to study liquid crystal compounds, polymers, etc. which make it possible to prepare the retardation film by a more simplified method.

### DETAILED DESCRIPTION OF THE INVENTION

### Technical Problem

Accordingly, an aspect of the present invention is to provide an optical film having a thin thickness and excellent reverse wavelength dispersion.

Another aspect of the present invention is to provide a display device including the optical film.

### Technical Solution

According to the present invention, an optical film is provided, including a copolymer containing a repeating unit derived from polymerization of 80 to 99.99% by weight of a compound represented by the following Chemical Formula 1 and 0.01 to 20% by weight of an acrylate-based compound and satisfying the following Equation I and Equation II.

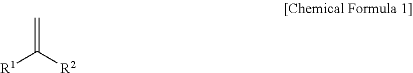

Herein, R¹ is hydrogen or a methyl group, and

R² is an aromatic hydrocarbon group having 5 to 20 carbon atoms or a heteroaromatic hydrocarbon group having 5 to 20 carbon atoms.

[Equation I]

Δn_{(450 nm)}/Δn_{(550 nm)}<1.0

[Equation II]

Δn_{(650 nm)}/Δn_{(550 nm)}>1.0

Herein, Δn(λ) means a specific birefringent index at the wavelength λ.

According to the present invention, the compound represented by Chemical Formula 1 may be one or more compounds selected from the group consisting of N-vinylcarbazole, N-vinylindole, 1-vinylnaphthalene, 1-vinylanthracene, and N-vinylphthalimide.

Further, according to the present invention, the acrylate-based compound may be a compound represented by the following Chemical Formula 2.

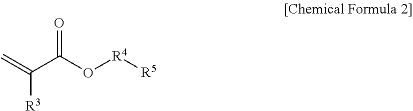

Herein, R³ is hydrogen or a substituted or unsubstituted alkyl group having 1 to 3 carbon atoms,

R⁴ is a single bond, a linear or branched alkylene having 1 to 20 carbon atoms, a linear or branched alkenylene having 2 to 20 carbon atoms, or a linear or branched alkynylene having 2 to 20 carbon atoms, and

R⁵ is hydrogen, a carboxyl group, or an epoxy group.

The copolymer may have a weight average molecular weight (Mw) of 10,000 to 3,000,000.

Further, the copolymer may have a glass transition temperature (Tg) of 100 to 300° C.

Meanwhile, according to the present invention, a method of preparing the optical film is provided, the method including: preparing a copolymer containing a repeating unit derived from polymerization of 80 to 99.99% by weight of a compound represented by the following Chemical Formula 1 and 0.01 to 20% by weight of an acrylate-based compound; forming a film containing the copolymer; and drawing the film.

### Advantageous Effects

The optical film according to the present invention has a thin thickness and excellent reverse wavelength dispersion, and thus it may be suitably applied to a λ/2 wave plate, a λ/4 wave plate, a protection film, and an anti-reflection film of a display device using liquid crystals or OLEDs.

### DETAILED DESCRIPTION OF THE EMBODIMENTS

Hereinafter, an optical film and a display device including the same according to embodiments of the present invention will be described.

In advance, unless otherwise specified throughout this specification, the specific birefringent index' means a phase difference value at a wavelength (λ) of light passing through the optical film, and it may be represented by Δn(λ).

The terminology used herein is only for the purpose of describing particular embodiments, and is not intended to be limiting of the invention. As used herein, singular forms are intended to include plural forms as well, unless the context clearly indicates otherwise.

It will be further understood that the terms ‘includes’ or ‘including’ when used in this specification, specify the presence of stated features, regions, integers, steps, operations, elements, or components, but do not preclude the addition of other features, regions, integers, steps, operations, elements, or components.

The present inventors have done intensive research into optical films, and they found that when a polymer obtained by copolymerizing a compound represented by the following Chemical Formula 1 and an acrylate-based compound, a vinyl-based compound, or a mixture thereof in a specific ratio is used as a resin for an optical film, the optical film becomes thin and has excellent reverse wavelength dispersion, thereby completing the present invention.

According to an embodiment of the present invention, an optical film including a copolymer containing a repeating unit derived from polymerization of 80 to 99.99% by weight of a compound represented by the following Chemical Formula 1 and 0.01 to 20% by weight of an acrylate-based compound and satisfying the following Equation I and Equation II is provided.

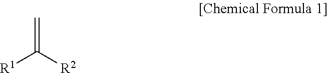

Herein, R¹ is hydrogen or a methyl group, and

R² is an aromatic hydrocarbon group having 5 to 20 carbon atoms or a heteroaromatic hydrocarbon group having 5 to 20 carbon atoms.

[Equation I]

Δn_{(450 nm)}/Δn_{(550 nm)}<1.0

[Equation II]

Δn_{(650 nm)}/Δn_{(550 nm)}>1.0

Herein, Δn(λ) means a specific birefringent index at the wavelength λ.

The optical film according to an embodiment includes a copolymer of a compound represented by the following Chemical Formula 1 and an acrylate-based compound that is copolymerizable therewith. In particular, the optical film according to a specific embodiment includes a polymer obtained by copolymerizing these compounds in a specific ratio, thereby having a thin thickness and showing excellent reverse wavelength dispersion. Therefore, the optical film may be suitably applied to a λ/2 wave plate, a λ/4 wave plate, a protection film, and an anti-reflection film of a display device using liquid crystals or OLEDs.

Hereinafter, the copolymer included in the optical film will be described.

The copolymer of an embodiment includes a repeating unit derived from a compound represented by the following Chemical Formula 1.

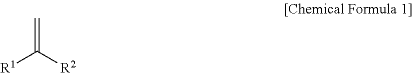

Herein, R¹ is hydrogen or a methyl group, and

R² is an aromatic hydrocarbon group having 5 to 20 carbon atoms or a heteroaromatic hydrocarbon group having 5 to 20 carbon atoms.

According to an embodiment, at least one hydrogen atom included in the aromatic hydrocarbon group and the heteroaromatic hydrocarbon group may be substituted by a hydroxyl group, a carboxyl group, a halogen atom, an alkyl group having 1 to 12 carbon atoms, an alkoxy group having 1 to 12 carbon atoms, an aryl group having 5 to 12 carbon atoms, an arylalkyl group having 7 to 12 carbon atoms, an acyl group having 2 to 4 carbon atoms, etc., and at least one methylene group included in the aromatic hydrocarbon group and the heteroaromatic hydrocarbon group may be substituted by —NH—, —O—, —S—, etc.

According to an embodiment, the compound represented by Chemical Formula 1 may be one or more compounds selected from the group consisting of N-vinylcarbazole, N-vinylindole, 1-vinylnaphthalene, 1-vinylanthracene, and N-vinylphthalimide. Among them, N-vinylcarbazole is a compound having a high refractive index and a high glass transition temperature, and may be advantageous in that heat resistance of the copolymer (i.e., heat stability upon heat molding) is obtained and excellent reverse wavelength dispersion of the copolymer is obtained.

Herein, the content of the compound represented by Chemical Formula 1 may be at least 80% by weight, preferably 80 to 99.99% by weight, 85 to 99% by weight, or 85 to 95% by weight. That is, the compound represented by Chemical Formula 1 may be preferably included in an amount of 80% by weight or more in order to obtain heat resistance and stable reverse wavelength dispersion of the copolymer.

The compound of an embodiment may include a repeating unit derived from a monomer that is copolymerizable with the compound represented by Chemical Formula 1.

The copolymerizable monomer may be used to obtain transparency, surface gloss, weather resistance, mechanical strength, and molding processability of the copolymer, and preferably, it may be an acrylate-based compound.

According to an embodiment, the acrylate-based compound may be a compound represented by the following Chemical Formula 2.

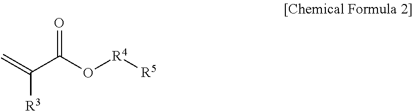

Herein, R³ is hydrogen or a substituted or unsubstituted alkyl group having 1 to 3 carbon atoms,

R⁴ is a single bond, a linear or branched alkylene having 1 to 20 carbon atoms, a linear or branched alkenylene having 2 to 20 carbon atoms, or a linear or branched alkynylene having 2 to 20 carbon atoms, and

R⁵ is hydrogen, a carboxyl group, or an epoxy group.

Non-limiting examples of the acrylate-based compound may include one or more compounds selected from the group consisting of acrylic acid, methacrylic acid, methyl acrylate, methyl methacrylate, butyl acrylate, butyl methacrylate, tertiary-butyl acrylate, tertiary-butyl methacrylate, iso-butyl acrylate, iso-butyl methacrylate, hexyl acrylate, hexyl methacrylate, 2-hydroxyethyl acrylate, 2-hydroxyethyl methacrylate, glycidyl acrylate, glycidyl methacrylate, benzyl acrylate, and benzyl methacrylate.

In addition to the acrylate-based compound, a monomer that is copolymerizable with the compound represented by Chemical Formula 1, for example, a vinyl-based compound, may be additionally used. Herein, the vinyl-based compound may be one or more compounds selected from the group consisting of ethylene, a linear alpha olefin having 3 to 20 carbon atoms, and a branched alpha olefin having 4 to 20 carbon atoms.

In an embodiment, the content of the copolymerizable monomer may be 20% by weight or less, preferably 0.01 to 20% by weight, 0.01 to 15% by weight, or 1 to 15% by weight. That is, the copolymerizable monomer may be preferably included in an amount of 0.01% by weight or more, in order to obtain transparency, surface gloss, weather resistance, mechanical strength, and molding processability of the copolymer. However, if the content of the copolymerizable monomer is higher than necessary, heat stability may be deteriorated upon heat molding of the copolymer, and it is difficult to obtain sufficient reverse wavelength dispersion. Therefore, the preferred content of the copolymerizable monomer is 20% by weight or less.

Considering processability and heat resistance required for the copolymer, a weight average molecular weight (Mw) of the copolymer may preferably be 10,000 to 3,000,000, 50,000 to 2,500,000, or 100,000 to 2,000,000.

Such copolymer may have a glass transition temperature (Tg) of 100 to 300° C., 150 to 300° C., or 150 to 250° C. to exhibit excellent heat resistance. Further, the copolymer has an excellent solubility property, and thus it is easy to process the copolymer and it is possible to form a flexible thin film.

In particular, the optical film of an embodiment may exhibit excellent reverse wavelength dispersion, thereby preferably satisfying the following Equation I and Equation II.

[Equation I]

Δn_{(450 nm)}/Δn_{(550 nm)}<1.0

[Equation II]

Δn_{(650 nm)}/Δn_{(550 nm)}>1.0

Herein, Δn(λ) means a specific birefringent index at the wavelength λ.

In particular, in terms of satisfying Equation I and Equation II, the optical film of an embodiment may have a difference between Δn_{(450 nm)} and Δn_{(650 nm)} values of 0.1 or more, preferably, 0.15 or more, thereby showing excellent reverse wavelength dispersion. That is, although any optical film satisfies the above equations, it does not show sufficient reverse wavelength dispersion if a difference between Δn_{(450 nm)} and Δn_{(650 nm)} values is less than 0.1. Therefore, the optical film may not be suitable for a λ/2 wave plate, a λ/4 wave plate, etc.

As such, the optical film according to an embodiment has excellent reverse wavelength dispersion, thereby being suitably applied to a λ/2 wave plate, a λ/4 wave plate, a protection film, and an anti-reflection film of a display device using liquid crystals or OLEDs. In particular, since glare is caused by reflection of incident light from a transistor in the display device using OLEDs, the film of an embodiment may be suitably used as a reverse wavelength dispersion film to prevent glare.

According to another embodiment of the present invention, a method of preparing the optical film is provided, the method including the steps of:

preparing a copolymer containing a repeating unit derived from polymerization of 80 to 99.99% by weight of the compound represented by Chemical Formula 1 and 0.01 to 20% by weight of the acrylate-based compound;

forming a film containing the copolymer; and

drawing the film.

In the preparation method of another embodiment, the step of preparing the copolymer may be performed by polymerizing a composition containing monomer compounds at 80 to 99.99% by weight of the compound represented by Chemical Formula 1 and 0.01 to 20% by weight of the acrylate-based compound, an organic solvent, and a polymerization initiator at a temperature of 20 to 120° C. for 1 to 24 h while stirring.

Herein, an organic solvent and a polymerization initiator generally used in the art to which the present invention pertains may be used in the polymerization reaction, and their types are not particularly limited.

According to an embodiment, the organic solvent may include aromatic hydrocarbons such as toluene, xylene, etc.; esters such as ethyl acetate, butyl acetate, ethylene glycol monomethylether acetate, ethylene glycol monoethylether acetate, propylene glycol monomethylether acetate, propylene glycol monoethylether acetate, etc.; aliphatic alcohols such as n-propyl alcohol, isopropyl alcohol, etc.; and ketones such as methyl ethyl ketone, methyl isobutyl ketone, etc.

According to an embodiment, the polymerization initiator may include azo-based compounds such as 2,2′-azobis isobutyronitrile, dimethyl-2,2′-azobis (2-methylpropionate), etc.; organic peroxides such as lauroyl peroxide, tert-butyl hydroperoxide, etc.; and inorganic peroxides such as hydrogen peroxide, potassium persulfate, etc.

The copolymer prepared by the above-described method may be formed as a film by solution casting or extrusion molding.

In this regard, the film including the copolymer may be formed on a substrate film including a cellulose triacetate film, a polyethylene terephthalate film, a cyclo olefin polymer film, a polycarbonate film, or a polynorbornene film.

Further, the optical film according to an embodiment may be obtained by monoaxially or biaxially drawing the film formed by the above method in the longitudinal or transverse direction. The copolymers included in the film may be oriented by the drawing process.

Hereinafter, actions and effects of the present invention will be explained in further detail with reference to the specific examples of the invention. However, it should be understood that these examples are merely illustrative of the present invention and the scope of the present invention is not to be determined thereby.

In the following examples and comparative examples, respective physical properties were measured by the following methods.

1) Weight average molecular weight: the prepared copolymer was dissolved in tetrahydrofuran, and gel permeation chromatography (GPC) was performed for measurement.

2) Glass transition temperature (Tg): a differential scanning calorimeter (DSC) manufactured by Ta Instruments was used for measurement.

3) Phase difference value: Axoscan manufactured by Axomatrix was used for measurement, thickness was independently measured, and Δn was determined from the obtained values.

### EXAMPLE 1

A monomer compound containing about 90% by weight of N-vinylcarbazole and about 10% by weight of acrylic acid, about 200 parts by weight of a solvent, toluene, based on 100 parts by weight of the monomer compound, and 0.05 parts by weight of a polymerization initiator, azobis isobutyronitrile were added to a reactor, and then polymerization reaction was allowed while stirring at about 70° C. for 18 h to obtain a solution containing a copolymer (with a weight average molecular weight of about 120,000 and a glass transition temperature of about 197° C.).

This solution was casted on a cyclo olefin polymer film (with a thickness of about 100 μm), and then dried and drawn in the longitudinal direction (about twice) to obtain an optical film having a thickness of about 67 μm (containing a substrate).

The phase difference values of the optical film were measured, resulting in Δn_{(450 nm)}=0.88, Δn_{(550 nm)}=1.00, and Δn_{(650 nm)}=1.07, and the optical film was found to satisfy the conditions according to Equation I and Equation II.

### EXAMPLE 2

A solution containing a copolymer (with a weight average molecular weight of about 130,000 and a glass transition temperature of about 202° C.) was obtained in the same manner as in Example 1, except that a monomer compound containing about 95% by weight of N-vinylcarbazole and about 5% by weight of acrylic acid was used. An optical film having a thickness of about 65 μm was obtained by performing the solution casting and drawing processes in the same manner as in Example 1, except that the above solution was used.

The phase difference values of the optical film were measured, resulting in Δn_{(450 nm)}=0.88, Δn_{(550 nm)}=1.00, and Δn (_{650 nm)}=1.06, and the optical film was found to satisfy the conditions according to Equation I and Equation II.

### EXAMPLE 3

A solution containing a copolymer (with a weight average molecular weight of about 150,000 and a glass transition temperature of about 215° C.) was obtained in the same manner as in Example 1, except that a monomer compound containing about 99% by weight of N-vinylcarbazole and about 1% by weight of acrylic acid was used. An optical film having a thickness of about 64 μm was obtained by performing the solution casting and drawing processes in the same manner as in Example 1, except that the above solution was used.

The phase difference values of the optical film were measured, resulting in Δn_{(450 nm)}=0.86, Δn_{(550 nm)}=1.00, and Δn_{(650 nm)}=1.10, and the optical film was found to satisfy the conditions according to Equation I and Equation II.

### EXAMPLE 4

A solution containing a copolymer (with a weight average molecular weight of about 135,000 and a glass transition temperature of about 210° C.) was obtained in the same manner as in Example 1, except that a monomer compound containing about 99.5% by weight of N-vinylcarbazole and about 0.5% by weight of acrylic acid was used. An optical film having a thickness of about 68 μm was obtained by performing the solution casting and drawing processes in the same manner as in Example 1, except that the above solution was used.

The phase difference values of the optical film were measured, resulting in Δn_{(450 nm)}=0.84, Δn_{(550 nm)}=1.00, and Δn_{(650 nm)}=1.12, and the optical film was found to satisfy the conditions according to Equation I and Equation II.

### EXAMPLE 5

A solution containing a copolymer (with a weight average molecular weight of about 150,000 and a glass transition temperature of about 203° C.) was obtained in the same manner as in Example 1, except that a monomer compound containing about 97% by weight of N-vinylcarbazole and about 3% by weight of 2-hydroxyethyl methacrylate was used. An optical film having a thickness of about 68 μm was obtained by performing the solution casting and drawing processes in the same manner as in Example 1, except that the above solution was used.

The phase difference values of the optical film were measured, resulting in Δn_{(450 nm)}=0.87, Δn_{(550 nm)}=1.00, and Δn_{(650 nm)}=1.09, and the optical film was found to satisfy the conditions according to Equation I and Equation II.

### EXAMPLE 6

A solution containing a copolymer (with a weight average molecular weight of about 150,000 and a glass transition temperature of about 195° C.) was obtained in the same manner as in Example 1, except that a monomer compound containing about 80% by weight of N-vinylcarbazole and about 20% by weight of acrylic acid was used. An optical film having a thickness of about 67 μm was obtained by performing the solution casting and drawing processes in the same manner as in Example 1, except that the above solution was used.

The phase difference values of the optical film were measured, resulting in Δn_{(450 nm)}=0.98, Δn_{(550 nm)}=1.00, and Δn_{(650 nm)}=1.02, and the optical film was found to satisfy the conditions according to Equation I and Equation II.

### COMPARATIVE EXAMPLE 1

A solution containing a copolymer (with a weight average molecular weight of about 90,000 and a glass transition temperature of about 160° C.) was obtained in the same manner as in Example 1, except that a monomer compound containing about 50% by weight of N-vinylcarbazole and about 50% by weight of acrylic acid was used. An optical film having a thickness of about 65 μm was obtained by performing the solution casting and drawing processes in the same manner as in Example 1, except that the above solution was used.

The phase difference values of the optical film were measured, resulting in Δn_{(450 nm)}=0.98, Δn_{(550 nm)}=1.00, and Δn_{(650 nm)}=1.01. That is, it was found that the optical film according to Comparative Example 1 satisfied the conditions according to Equation I and Equation II, but did not exhibit sufficient reverse wavelength dispersion, compared to the films of the examples.

### COMPARATIVE EXAMPLE 2

A solution containing a copolymer (with a weight average molecular weight of about 80,000 and a glass transition temperature of about 120° C.) was obtained in the same manner as in Example 1, except that a monomer compound containing about 10% by weight of N-vinylcarbazole and about 90% by weight of acrylic acid was used. An optical film having a thickness of about 58 μm was obtained by performing the solution casting and drawing processes in the same manner as in Example 1, except that the above solution was used.

The phase difference values of the optical film were measured, resulting in Δn_{(450 nm)}=1.03, Δn_{(550 nm)}=1.00, and Δn_{(650 nm)}=0.99. That is, the optical film according to Comparative Example 2 did not satisfy the conditions according to Equation I and Equation II. In Comparative Example 2, the film became very opaque during preparation, such that the film was not suitable as the optical film.

### COMPARATIVE EXAMPLE 3

A solution containing a copolymer (with a weight average molecular weight of about 90,000 and a glass transition temperature of about 145° C.) was obtained in the same manner as in Example 1, except that a monomer compound containing about 75% by weight of N-vinylcarbazole and about 25% by weight of acrylic acid was used. An optical film having a thickness of about 65 μm was obtained by performing the solution casting and drawing processes in the same manner as in Example 1, except that the above solution was used.

The phase difference values of the optical film were measured, resulting in A n_{(450 nm)}=0.98, Δn_{(550 nm)}=1.00, and Δn_{(650 nm)}=1.02. The optical film according to Comparative Example 3 satisfied the conditions according to Equation I and Equation II, but did not exhibit sufficient reverse wavelength dispersion, compared to the films of the examples. Further, in Comparative Example 3, the film became very opaque during preparation, such that the film was not suitable as the optical film.

1. An optical film comprising a copolymer including a repeating unit derived from polymerization of 80 to 99.99% by weight of a compound represented by the following Chemical Formula 1 and 0.01 to 20% by weight of an acrylate-based compound and satisfying the following Equation I and Equation II: 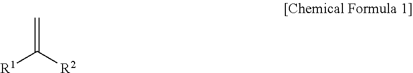
wherein R¹ is hydrogen or a methyl group; and
R² is an aromatic hydrocarbon group having 5 to 20 carbon atoms or a heteroaromatic hydrocarbon group having 5 to 20 carbon atoms, and at least one hydrogen atom included in the aromatic hydrocarbon group and the heteroaromatic hydrocarbon group is substituted by a hydroxyl group, a carboxyl group, a halogen atom, an alkyl group having 1 to 12 carbon atoms, an alkoxy group having 1 to 12 carbon atoms, an aryl group having 5 to 12 carbon atoms, an arylalkyl group having 7 to 12 carbon atoms, or an acyl group having 2 to 4 carbon atoms;
[Equation I]
Δn_{(450 nm)}/Δn_{(550 nm)}<1.0
[Equation II]
Δn_{(650 nm)}/Δn_{(550 nm)}>1.0
wherein Δn(λ) means a specific birefringent index at the wavelength λ.

2. The optical film of claim 1, wherein the compound represented by Chemical Formula 1 is one or more compounds selected from the group consisting of N-vinylcarbazole, N-vinylindole, 1-vinylnaphthalene, 1-vinylanthracene, and N-vinylphthalimide.

3. The optical film of claim 1, wherein the acrylate-based compound is a compound represented by the following Chemical Formula 2: 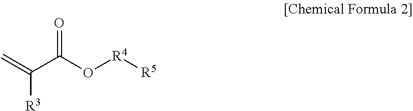
wherein R³ is hydrogen or a substituted or unsubstituted alkyl group having 1 to 3 carbon atoms,
R⁴ is a single bond, linear or branched alkylene having 1 to 20 carbon atoms, a linear or branched alkenylene having 2 to 20 carbon atoms, or a linear or branched alkynylene having 2 to 20 carbon atoms, and
R⁵ is hydrogen, a carboxyl group, or an epoxy group.

4. The optical film of claim 1, wherein the copolymer has a weight average molecular weight (Mw) of 10,000 to 3,000,000.

5. The optical film of claim 1, wherein the copolymer has a glass transition temperature (Tg) of 100 to 300° C.

6. A method of preparing the optical film of claim 1, the method comprising the steps of:
preparing a copolymer including a repeating unit derived from polymerization of 80 to 99.99% by weight of a compound represented by the following Chemical Formula 1 and 0.01 to 20% by weight of an acrylate-based compound;
forming a film including the copolymer; and
drawing the film: 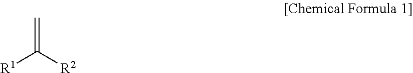
wherein R¹ is hydrogen or a methyl group; and
R² is an aromatic hydrocarbon group having 5 to 20 carbon atoms or a heteroaromatic hydrocarbon group having 5 to 20 carbon atoms, and at least one hydrogen atom included in the aromatic hydrocarbon group and the heteroaromatic hydrocarbon group is substituted by a hydroxyl group, a carboxyl group, a halogen atom, an alkyl group having 1 to 12 carbon atoms, an alkoxy group having 1 to 12 carbon atoms, an aryl group having 5 to 12 carbon atoms, an arylalkyl group having 7 to 12 carbon atoms, or an acyl group having 2 to 4 carbon atoms.

7. The method of claim 6, wherein the film including the copolymer is formed on a substrate film including a cellulose triacetate film, a polyethylene terephthalate film, a cyclo olefin polymer film, a polycarbonate film, or a polynorbornene film.

8. A display device comprising the optical film of claim 1.
